(19) United States
(12) Patent Application Publication
(10) Pub. No.: US 2026/0318023 A1
(43) Pub. Date: Oct. 15, 2026

(54) SNOW REMOVAL DEVICE

(71) Applicants: Diana Marski, Youngstown, OH (US); Ruddy Adam Jaquez, Effort, PA (US)

(72) Inventors: Diana Marski, Youngstown, OH (US); Ruddy Adam Jaquez, Effort, PA (US)

(21) Appl. No.: 19/645,691

(22) Filed: Apr. 13, 2026

Related U.S. Application Data
(60) Provisional application No. 63/788,214, filed on Apr. 14, 2025.

(51) Int. Cl. E01H 5/02; B25G 1/04; B25G 3/26

(52) U.S. Cl. CPC E01H 5/02; B25G 1/04; B25G 3/26

(57) ABSTRACT

A snow removal device is provided. The device is configured for the removal of snow, slush, water, and similar materials from flat surfaces including but not limited to sidewalks, driveways, patios, and decks. The device comprises a shaft body. A primary grip area is disposed near the proximal end of the shaft and comprises non-slip materials with optional texturing to enhance user grip. In one embodiment, a secondary grip handle may be positioned below the primary grip area and may similarly include ergonomic configurations and non-slip materials for improved leverage and two-handed operation. A strap may be attached near the primary grip area for securing the device to the wrist or for storage. At the distal end of the shaft, a mounting bracket connects to a blade support assembly. The blade support assembly houses a flexible scraping blade.

### CROSS-REFERENCE TO RELATED APPLICATION

The present application claims priority to, and the benefit of, U.S. Provisional Application No. 63/788,214, which was filed on Apr. 14, 2025, and is incorporated herein by reference in its entirety.

### FIELD OF THE INVENTION

The present invention relates generally to the field of snow-clearing devices. More specifically, the present invention relates to a device that is configured for the removal of snow, slush, water, and similar materials from flat surfaces such as sidewalks, driveways, patios, and decks via a flexible blade. Accordingly, the present disclosure makes specific reference thereto. Nonetheless, it is to be appreciated that aspects of the present invention are also equally applicable to other like applications, devices, and methods of manufacture.

### BACKGROUND

Snow and ice accumulation on flat outdoor surfaces poses a recurring seasonal challenge, particularly in regions subject to freezing temperatures. Surfaces such as sidewalks, driveways, patios, and decks often become hazardous due to the buildup of snow, slush, and residual water, increasing the risk of slips, falls, and other accidents. Traditional snow removal methods typically rely on shovels, brooms, or snow blowers. These tools often require users to exert significant physical effort, including lifting, bending, and twisting, which may lead to strain injuries, back pain, and in severe cases, cardiovascular events such as heart attacks. Elderly individuals and those with preexisting health conditions are particularly vulnerable to such outcomes. Furthermore, many of these tools are either too heavy, inefficient for light snowfall, or ineffective at clearing slush and thin water films. Additionally, existing solutions do not always accommodate varying user heights or ergonomic preferences, limiting their effectiveness and comfort during prolonged use.

Therefore, there exists a long-felt need in the art for a snow removal device that facilitates the efficient clearance of snow, slush, and water from various flat surfaces without requiring users to bend or lift. There also exists a long-felt need in the art for a snow removal device that accommodates different user heights and ergonomic preferences through an adjustable or modular design. Moreover, there exists a long-felt need in the art for a snow removal device that operates effectively on a range of surface materials such as concrete, pavement, wood, and composite decking.

The subject matter disclosed and claimed herein, in one embodiment thereof, comprises a snow removal device. The device is configured for the removal of snow, slush, water, and similar materials from flat surfaces including but not limited to sidewalks, driveways, patios, and decks. The device comprises a shaft body that may be fixed in length or telescopic and includes a locking mechanism. A primary grip area is disposed near the proximal end of the shaft and comprises non-slip materials with optional texturing to enhance user grip. In one embodiment, a secondary grip handle may be positioned below the primary grip area and may similarly include ergonomic configurations and non-slip materials for improved leverage and two-handed operation. A strap may be attached near the primary grip area for securing the device to the wrist or for storage. At the distal end of the shaft, a mounting bracket connects to a blade support assembly. The blade support assembly houses a flexible scraping blade that may have embedded reinforcement features to maintain blade integrity and effectiveness under operational stresses.

In this manner, the snow removal device of the present invention accomplishes all the foregoing objectives and provides a device that enables users to remove snow, slush, and water efficiently without requiring lifting or bending, thereby reducing physical strain and associated health risks. The inclusion of an adjustable telescopic shaft and ergonomic grip configurations further addresses the need for accommodation of various user heights and physical capabilities. The integration of a reinforced flexible blade and adaptable blade support assembly ensures effective operation across a range of surface types and environmental conditions. As such, the snow removal device offers a practical and reliable solution to the longstanding problems associated with traditional snow removal methods.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a snow removal device. The device is comprised of a tool configured for the removal of snow, slush, water, and similar materials from surfaces including sidewalks, pavement, driveways, decks, patios, and concrete slabs. The device is comprised of a shaft body. In one embodiment, the shaft body is of a fixed length. In another embodiment, the shaft body is telescopic and includes a locking mechanism for adjustable length.

A primary grip area is positioned near the proximal end of the shaft body and is comprised of non-slip materials. The grip area may include at least one texture to improve hand traction in wet or icy conditions. In one embodiment, the primary grip area is integrally formed as a surface region of the shaft body. In another embodiment, the primary grip area is a handle element differing in shape from the shaft body. A secondary grip handle may also be positioned below the primary grip area to provide enhanced leverage and two-handed control. The secondary grip handle may also be comprised of a grip area made of non-slip materials and includes textures for improved traction. A strap may be attached near or to the primary grip area, serving as a wrist loop to prevent dropping and as a hanging loop for storage.

A mounting bracket is positioned at the distal end of the shaft body and serves as a structural interface between the shaft body and a blade support assembly. The blade support assembly is mechanically coupled to the mounting bracket and is configured to retain a flexible scraping blade. The blade support assembly is comprised of a continuous frame for secure retention of the blade and may include a securing fastener that allows for removal and replacement of the blade. The flexible scraping blade is comprised of an elastomer or rubber-based material that maintains flexibility at low temperatures while providing rigidity for effective displacement of snow, slush, water, or fragmented ice. The blade may further be comprised of at least one reinforcement feature to enhance stability and durability during operation.

Accordingly, the snow removal device of the present invention is particularly advantageous as it provides a device that enables users to remove snow, slush, and water efficiently without requiring lifting or bending, thereby reducing physical strain and associated health risks. The inclusion of an adjustable telescopic shaft and ergonomic grip configurations further addresses the need for accommodation of various user heights and physical capabilities. The integration of a reinforced flexible blade and adaptable blade support assembly ensures effective operation across a range of surface types and environmental conditions. As such, the snow removal device offers a practical and reliable solution that overcomes the longstanding problems associated with traditional snow removal methods and devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a snow removal device of the present invention in accordance with the disclosed architecture; and

FIG. 2 illustrates an enhanced perspective view of one potential embodiment of a snow removal device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a snow removal device that facilitates the efficient clearance of snow, slush, and water from various flat surfaces without requiring users to bend or lift. There also exists a long-felt need in the art for a snow removal device that accommodates different user heights and ergonomic preferences through an adjustable or modular design. Moreover, there exists a long-felt need in the art for a snow removal device that operates effectively on a range of surface materials such as concrete, pavement, wood, and composite decking.

The present invention, in one exemplary embodiment, is comprised of a snow removal device. The device is designed for the removal of snow, slush, water, and similar materials from surfaces such as sidewalks, pavement, driveways, decks, patios, and concrete slabs. The device includes a shaft body, which in one embodiment is of a fixed length. In an alternative embodiment, the shaft body is telescopic and features a locking mechanism to allow for length adjustment.

Positioned near the proximal end of the shaft body is a primary grip area, which is comprised of non-slip materials. To enhance hand traction in wet or icy conditions, the grip area may include at least one textured surface. In one configuration, the primary grip area is integrally formed with the shaft body. In another configuration, the primary grip area is formed as a distinct handle element differing in shape from the shaft body. Additionally, a secondary grip handle may be located below the primary grip area to provide improved leverage and two-handed control. The secondary grip handle is also comprised of a grip area made from non-slip materials and includes textures to enhance traction. A strap may be affixed near or to the primary grip area and serves both as a wrist loop to prevent accidental dropping and as a hanging loop for storage.

At the distal end of the shaft body, a mounting bracket is positioned to act as a structural interface between the shaft body and a blade support assembly. The blade support assembly is mechanically attached to the mounting bracket and is designed to retain a flexible scraping blade. This assembly includes a continuous frame for secure blade retention and may incorporate a securing fastener that allows the blade to be removed and replaced. The flexible scraping blade is comprised of an elastomer or rubber-based material that remains flexible at low temperatures while maintaining sufficient rigidity for displacing snow, slush, water, or fragmented ice. At least one reinforcement feature may be included in the blade to improve stability and durability during operation.

As a result, the device offers significant advantages by enabling efficient removal of snow, slush, and water without requiring lifting or bending, thereby minimizing physical strain and reducing associated health risks. The inclusion of an adjustable telescopic shaft and ergonomic grip configurations further accommodates a range of user heights and physical capabilities. In addition, the combination of a reinforced flexible blade with an adaptable blade support assembly ensures effective performance across diverse surface types and environmental conditions. As a result, the device presents a practical and dependable solution to the limitations found in traditional snow removal tools.

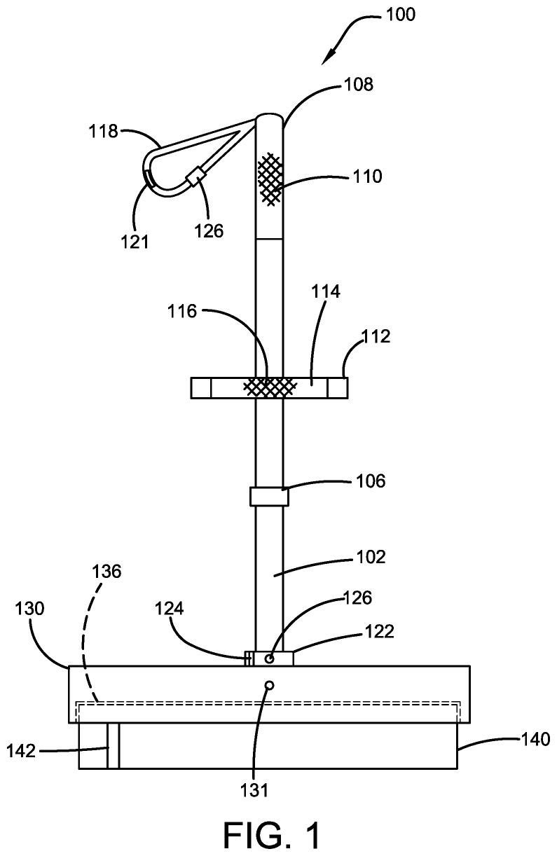

Referring initially to the drawings, FIG. 1 illustrates a front view of one potential embodiment of a snow removal device 100 of the present invention in accordance with the disclosed architecture. The device 100 is comprised of a tool configured for the removal of snow, slush, water, and similar materials from surfaces such as but not limited to sidewalks, pavement, driveways, decks, patios, and concrete slabs.

The device 100 is comprised of a shaft body 102. The body 102 may be comprised of materials such as but not limited to any combination of wood, aluminum, stainless steel, carbon fiber, fiberglass, or high-strength polymer composites. In one embodiment, the body 102 is of a fixed length. In another embodiment, the body 102 may be telescopic, allowing length adjustment to suit various user heights or application scenarios. In this embodiment, the body 102 is comprised of a locking mechanism 106 that may be comprised of but is not limited to any combination of a twist-lock, spring-loaded pin, cam-lock lever, detent button, or clamp collar, among other mechanical fasteners.

A primary grip area 108 may be positioned near the proximal end of the body 102. The grip area 108 may be comprised of non-slip materials such as but not limited to any combination of thermoplastic elastomer, foam, rubber, or synthetic composite. The grip area 108 may further include at least one texture 110 such as but not limited to any combination of grooves, cross-hatching, stippling, or molded ridges to improve hand traction in wet or icy conditions.

In one embodiment, the primary grip area 108 may be integrally formed as a surface region of the body 102. In another embodiment, the primary grip area 108 is in a form of a handle element that differs from the shape of the body 102. In this embodiment, the grip area 108 may be comprised of various geometries including but not limited to any combination of a perpendicular T-grip, an arched D-grip, a post handle, or a vertical loop handle. This embodiment may provide alternative gripping configurations to suit user preference or application-specific ergonomic requirements.

In one embodiment, a secondary grip handle 112 may be positioned below the primary grip area 108 (as seen in FIG. 1) to provide enhanced leverage and two-handed control during operation. The secondary grip handle 112 may be comprised of various geometries including but not limited to any combination of a perpendicular T-grip, an arched D-grip, a post handle, a vertical loop handle, or may wrap around the body 102 in a cylindrical fashion. The secondary handle 112 may also be comprised of a grip area 114 that may be comprised of non-slip materials such as but not limited to thermoplastic elastomer, foam, rubber, or synthetic composite. The grip area 114 may further include at least one texture 116 such as but not limited to any combination of grooves, cross-hatching, stippling, or molded ridges to improve hand traction in wet or icy conditions.

In one embodiment, a strap 118 may be attached near or to the primary grip area 108, as seen in FIG. 1. The strap 118 may serve as a wrist loop to prevent dropping the device 100 during use, and as a hanging loop for storage. The strap 118 may be comprised of materials such as but not limited to woven nylon, polyester webbing, leather, or reinforced fabric composites. The strap 118 may be adjustable via an adjustment fastener 120 such as but not limited to a sliding buckle, hook-and-loop fastener, ladder lock, or other tensioning mechanisms. The strap 118 may be comprised of a padding 121 that may be incorporated to provide wrist comfort and ergonomic support during extended use.

A mounting bracket 122 is positioned at the distal end of the body 102 and serves as a structural interface between the body 102 and a blade support assembly 130, as seen in FIG. 1. The mounting bracket 122 may be comprised of any type of mechanical or molded bracket and may be comprised of high-strength metals such as stainless steel or anodized aluminum. The bracket 122 may also be comprised of reinforcements 124 such as but not limited to any combination of lateral flanges, gussets, or reinforcement ribs to prevent deformation under high-force scraping. Attachment of the bracket 122 to the body 102 may be accomplished via fasteners 126 such as but not limited to any combination of mechanical screws, rivets, bolts, or molded inserts.

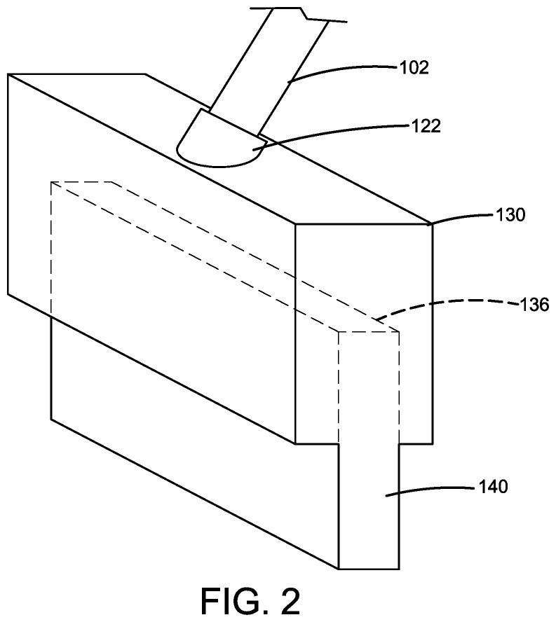

The blade support assembly 130 is mechanically coupled to the mounting bracket 122 and may be configured to retain a flexible scraping blade 140. The blade support assembly 130 may be comprised of a continuous receiving area 136 that grips and supports the blade 140 securely such as, but not limited to, a channel, an opening, etc. as seen in FIG. 1 and FIG. 2. In one embodiment, the blade support assembly 130 is comprised of a securing fastener 131 such as but not limited to a channel, a set screw, a mechanical clip, a bracketed clamp, or any other fastener that removably secures the blade 140 and allows for the blade 140 to be easily replaced as needed.

The flexible scraping blade 140 may be comprised of an elastomer or rubber-based material designed to maintain flexibility at low temperatures while offering sufficient rigidity to displace accumulated snow, slush, water, or fragmented ice. Suitable materials for the blade 140 may include but are not limited to thermoplastic elastomer, vulcanized rubber, polyurethane, silicone-based compounds, or synthetic blends with cold-weather durability. In one embodiment, the blade 140 is comprised of at least one reinforcement feature 142 such as but not limited to an embedded fabric mesh, internal ribs, laminated stiffener strips, or molded structural ridges that may enhance blade stability during operation and reduce wear over time.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “snow removal device” and “device” are interchangeable and refer to the snow removal device 100 of the present invention.

Notwithstanding the foregoing, the snow removal device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the snow removal device 100 as shown in the FIGS. are for illustrative purposes only, and that many other sizes and shapes of the snow removal device 100 are well within the scope of the present disclosure. Although the dimensions of the snow removal device 100 are important design parameters for user convenience, the snow removal device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A snow removal device comprising:
a shaft body;
a primary grip area positioned on the shaft body, the primary grip area comprising a non-slip material and a texture;
a mounting bracket positioned on the shaft body;
a blade support assembly mechanically coupled to the mounting bracket; and
a flexible scraping blade retained by the blade support assembly.

2. The snow removal device of claim 1, wherein the non-slip grip material is comprised of a thermoplastic elastomer, a foam, a rubber, or a synthetic composite.

3. The snow removal device of claim 1, wherein the texture is comprised of a groove, a cross-hatching, a stippling, or a molded ridge.

4. The snow removal device of claim 1, wherein the primary grip area is comprised of a perpendicular T-grip, an arched D-grip, a post handle, or a vertical loop handle.

5. The snow removal device of claim 1, wherein the shaft body is comprised of a cylindrical shaft body.

6. The snow removal device of claim 5, wherein the primary grip area is cylindrical.

7. The snow removal device of claim 1 further comprised of a strap.

8. The snow removal device of claim 7, wherein the strap is comprised of an adjustment fastener.

9. The snow removal device of claim 7, wherein the strap is comprised of a padding.

10. A snow removal device comprising:
a shaft body;
a primary grip area positioned on the shaft body, the primary grip area comprising a non-slip material and a texture;
a secondary grip handle positioned below the primary grip area;
a mounting bracket positioned on the shaft body;
a blade support assembly mechanically coupled to the mounting bracket; and
a scraping blade retained by the blade support assembly.

11. The snow removal device of claim 10, wherein the secondary grip handle is comprised of a perpendicular T-grip, an arched D-grip, a post handle, or a vertical loop handle.

12. The snow removal device of claim 10, wherein the secondary grip handle is comprised of a secondary grip area.

13. The snow removal device of claim 11, wherein the secondary grip area is comprised of a non-slip material.

14. The snow removal device of claim 13, wherein the non-slip material is comprised of a thermoplastic elastomer, a foam, a rubber, or a synthetic composite.

15. The snow removal device of claim 12, wherein the secondary grip area is comprised of a secondary texture.

16. The snow removal device of claim 15, wherein the secondary texture is comprised of a groove, a cross-hatching, a stippling, or a molded ridge.

17. A snow removal device comprising:
a telescopic shaft body comprised of a locking mechanism;
a primary grip area positioned on the shaft body, the primary grip area comprising a non-slip material and a texture;
a secondary grip handle positioned below the primary grip area;
a mounting bracket positioned on the shaft body;
a blade support assembly mechanically coupled to the mounting bracket; and
a scraping blade retained by the blade support assembly.

18. The snow removal device of claim 17, wherein the locking mechanism is comprised of a twist-lock, a spring-loaded pin, a cam-lock lever, a detent button, or a clamp collar.

19. The snow removal device of claim 17, wherein the blade support assembly is comprised of a securing fastener.

20. The snow removal device of claim 17, wherein the scraping blade is comprised of a flexible material and is comprised of a reinforcement feature.
